(19) United States
(12) Patent Application Publication
(10) Pub. No.: US 2026/0221515 A1
(43) Pub. Date: Jul. 30, 2026

(54) SOLID-STATE BATTERY AND PREPARATION METHOD THEREOF

(71) Applicant: TIANNENG BATTERY GROUP CO., LTD., Huzhou, Zhejiang (CN)

(72) Inventors: Haiyuan ZHANG, Huzhou, Zhejiang (CN); Yu LI, Huzhou, Zhejiang (CN); Haimin ZHAO, Huzhou, Zhejiang (CN); Hao ZHANG, Huzhou, Zhejiang (CN); Guang HE, Huzhou, Zhejiang (CN); Yifei LU, Huzhou, Zhejiang (CN); Hongjie WANG, Huzhou, Zhejiang (CN); Kunguang HONG, Huzhou, Zhejiang (CN); Shuqiang WANG, Huzhou, Zhejiang (CN)

(21) Appl. No.: 19/143,904

(22) PCT Filed: Apr. 17, 2023
(86) PCT No.: PCT/CN2023/088682

§ 371 Date: Aug. 29, 2025

(30) Foreign Application Priority Data
Dec. 30, 2022 (CN) 202211713035.0

(51) Int. Cl. H01M 10/058; H01M 10/052; H01M 10/44; H01M 10/52; H01M 50/609

(52) U.S. Cl. CPC H01M 10/058; H01M 10/052; H01M 10/446; H01M 10/52; H01M 50/609; H01M 2300/0065; H01M 2300/0085

(57) ABSTRACT

Disclosed in the present disclosure is a solid-state battery and a preparation method therefor. According to the preparation method, for a solid-state lithium-ion pouch battery using an in-situ polymerization method, an interface-free effect can be achieved through a two-time liquid injection process, thereby allowing an electrolyte solution to undergo full formation before in-situ polymerization, a full reaction, full gas production and degassing, and achieving the purposes of bubble-free solidification, improving initial efficiency and improving cycle performance of a battery cell. With respect to the problem that initiators cannot be injected, an initiator is mixed with a small amount of a volatile solubilizer to form a second polymer precursor, a first polymer precursor and the second polymer precursor are injected separately, The second polymer precursor and the first polymer precursor can be fully mixed by the in-situ polymerization under a certain polymerization pressure, thereby making a polymerization reaction more uniform.

### CROSS-REFERENCE TO RELATED APPLICATIONS

The present application is a National Stage of International Patent Application No. PCT/CN2023/088682 filed on Apr. 17, 2023, which claims the benefit of the priority to Chinese Patent Application No. 2022117130350 filed on Dec. 30, 2022, the disclosure of which is hereby incorporated by reference in its entirety.

### TECHNICAL FIELD

The present disclosure relates to the technical field of secondary batteries, and particularly relates to a solid-state battery and a preparation method therefor.

### BACKGROUND

With development of lithium battery technologies, solid-state batteries have attracted increasing attention from researchers. Electrolyte solutions are key components of lithium-ion batteries. The currently used electrolyte solutions are all organic compounds, which can cause problems such as liquid leakage and combustion under extreme operating conditions. In order to solve the problem of safety of lithium batteries, all-solid-state electrolytes have been extensively studied. The solid-state batteries containing the all-solid-state electrolytes can significantly improve safety performance and are one of development trends of the lithium batteries in the future.

Polymer all-solid-state electrolytes possess excellent safety performance and can be produced on existing lithium-ion battery production equipment, thereby reducing investment in equipment and plant. Therefore, polymer solid-state electrolytes have been widely studied in various major research institutions and large lithium-ion battery companies. Many polymer solid-state electrolytes are prepared by an in-situ polymerization method. An in-situ polymerization technology, commonly referred to as an in-situ solidification technology by researchers, usually includes injecting a liquid monomer into a battery cell by a liquid injection manner and then initiating polymerization of the monomer under certain conditions after completion of impregnation to form an in-situ solid-state battery. For example, a Chinese patent application with publication No. CN105914405A proposes that a liquid epoxy compound and a lithium salt are injected into a battery to initiate in-situ ring-opening solidification under heating conditions to form an integrated all-solid-state polymer battery. In a Chinese patent application with publication No. CN108493486A, an acrylate and an initiator are used and dissolved in an electrolyte solution and then injected into a battery to initiate polymerization of an unsaturated double bond under heating conditions to form an integrated gel polymer battery. In a Chinese patent application with publication No. CN111533851A, a small-molecular alkenyl carbonate containing a double bond, ethylene glycol acrylate and an initiator are used, mixed and injected into an interface of a solid-state battery to initiate polymerization by heat to form an integrated electrode-electrolyte all-solid-state battery. In a Chinese patent application with publication No. CN111540956A, an isocyanate and polypropylene glycol are dissolved in an electrolyte solution and then injected into a battery for polymerization to form an integrated battery, thereby reducing interface impedance between an electrode and an electrolyte.

Meanwhile, there are different ways for preparing batteries using the in-situ polymerization method. For example, in a Chinese patent application with publication No. CN110048158A, a pouring way is utilized to respectively perform in-situ polymerization on two sides of a porous membrane to form an electrolyte membrane with a double-layer structure having one ester face and one ether face, and the membrane simultaneously meets stability demands of a high-voltage cathode and a low-voltage anode. In a Chinese patent application with publication No. CN110581314A, one side of a support diaphragm in contact with a cathode is coated with an inorganic solid-state electrolyte, and one side of the support diaphragm in contact with an anode is coated with a polymer electrolyte, thereby reducing oxidation of the electrolytes and improving safety and cycle stability of a battery. However, currently reported multilayer composite membranes have complex processes and are mostly obtained by performing coating to form membranes outside battery cells and then performing compounding with electrode sheets, electrolytes and electrodes have poor interface contact and high impedance, and utilization of battery capacities is not facilitated. In a Chinese patent application with publication No. CN114335716A, a reactive monomer is mixed into a cathode and an anode, and a cross-linking agent and other reaction auxiliary agents are added into an electrolyte solution to perform in-situ polymerization.

Considering the compatibility with existing lithium batteries, cost, convenience in equipment transformation and other industrialization factors of the lithium batteries, regardless of changes in the ways for preparing batteries using the in-situ polymerization, processes such as a liquid injection process and an in-situ polymerization process still remain indispensable. Moreover, the in-situ polymerization after direct liquid injection is a simplest and most convenient battery preparation process method. However, researchers have paid more attention to structures and polymerization reactions of materials in in-situ polymerization studies, and have carried out few studies on practical processes such as liquid injection during industrialization of the solid-state batteries. Process problems appeared during the industrialization, such as residual liquid, severe gas production, uneven polymerization, and low initial efficiency, have rarely been addressed with solutions. Products obtained by the in-situ polymerization are all-solid-state polymer electrolytes, with no presence of liquid electrolyte solutions therein, which are also different from semi-solid electrolytes. Since the products are the all-solid-state electrolyte and batteries, compared with semi-solid electrolyte batteries, formulations and process parameters for the in-situ polymerization are different and require redesign.

### SUMMARY

To solve the above problems, an industrializable production process for an interface-free solid-state battery with a three-dimensional network electrolyte is proposed.

To address problems such as premature polymerization, many side reactions and gas production caused by one-time liquid injection, a two-time liquid injection process is developed. However, since an initiator is a solid powder that cannot undergo two-time liquid injection and even mixing, a solubilizer is selected to promote dissolution and complete mixing of the initiator.

A method for preparing a solid-state battery is provided, the solid-state battery includes a dry battery cell, and the method includes the following steps:
(1) performing first liquid injection into the dry battery cell by injecting a first polymer precursor, wherein the first polymer precursor includes a reactive monomer and a lithium salt, and further includes or does not include a cross-linking agent;
(2) performing first formation and then first degassing;
(3) performing second liquid injection by injecting a second polymer precursor, wherein the second polymer precursor includes an initiator and a solubilizer, and the solubilizer is a volatile solvent;
(4) performing vacuum degassing to remove the solubilizer, and then allowing the reactive monomer and the cross-linking agent to undergo in-situ polymerization under the action of the initiator; and
(5) performing second formation and second degassing.

The reactive monomer is an organic reactive monomer that contains a double bond or a cyclic functional group and is capable of undergoing free radical polymerization to generate a high-molecular long-chain polymer with a freely movable chain segment.

The initiator is an azo initiator, a peroxide initiator, or an anionic or cationic initiator that plays an initiation role in high-molecular free radical polymerization of the reactive monomer.

The cross-linking agent is an organic compound containing a bifunctional group or a multifunctional group that can be combined with the free radical reactive monomer.

When the cross-linking agent is not added, the reactive monomer can also be polymerized by itself. However, an appropriate amount of the cross-linking agent added can make linear molecules of the reactive monomer interconnected to form a network structure, thereby enhancing the elasticity. Meanwhile, the addition amount of the cross-linking agent cannot be excessive, and the excessive cross-linking agent hardens a polymerization product and affects battery performance.

Preferably, the reactive monomer is selected from the group consisting of: vinyl acetate, dimethyl allyldicarboxylate, diethyl allylmalonate, dimethallyl carbonate, 1,4-butanediol diacrylate, 1,6-hexanediol diacrylate, methyl methacrylate, butyl methacrylate, vinylene carbonate, vinylethylene carbonate, methyl vinyl sulfone, ethyl vinyl sulfone, ethoxylated trimethylolpropane triacrylate, pentaerythritol triacrylate, pentaerythritol tetraacrylate, dipentaerythritol pentaacrylate, dipentaerythritol hexaacrylate, acrylamide, N,N-methylenebisacrylamide, caprolactam, butyrolactam, maleic anhydride, acrylonitrile, ethyl 2-cyanoacrylate, butyl 2-cyano-2-acrylate, isooctyl 2-cyano-3,3-diphenylacrylate, 1-cyclohexene acetonitrile, hexafluorobutyl methacrylate, trifluoroethyl methacrylate, poly(ethylene glycol) methacrylate, poly(ethylene glycol) dimethacrylate, poly(ethylene glycol) diacrylate, ethoxyethyl acrylate, polyethylene glycol, 1,3-dioxolane, dioxane, vinylmethoxysilane, ethyl 2-(trimethylsiloxy) methacrylate, trivinylcyclotrisiloxane, and tris(2-methoxyethoxy) vinylsilane.

The cross-linking agent is selected from the group consisting of: poly(ethylene glycol) diacrylate, poly(ethylene glycol) dimethacrylate, trimethylolpropane trimethacrylate, pentaerythritol tetraacrylate, pentaerythritol triacrylate, ethoxylated trimethylolpropane triacrylate, and polyether polyacrylate.

The lithium salt is selected from the group consisting of: LiBF₄, LiBF₆, LiFSI, LiTFSI, LiAsF₆, LiPF₆, LiClO₄, LiB(C₆H₅)₄, LiAlCl₄, LiBr, LiCF₃SO₃, LiN(CF₃SO₂)₂, LiC(CF₃SOSO₂)₃, LiN(SO₂C₂F₅)₂, and Li[B(O₄C₂)]₂.

The initiator is selected from the group consisting of: azobisisobutyronitrile, azobisisoheptonitrile, dimethyl azobisisobutyrate, benzoyl peroxide, tert-butyl benzoyl peroxide, methyl ethyl ketone peroxide, di-tert-butyl peroxide, aluminum trifluoromethanesulfonate, magnesium trifluoromethanesulfonate, lithium bis(fluorosulfonyl)imide, and tin trifluoromethanesulfonate.

Preferably, the solubilizer is selected from the group consisting of: ethyl ether, pentane, dichloromethane, carbon disulfide, acetone, chloroform, tetrahydrofuran, 2-methyltetrahydrofuran, ethanol, methanol, hexane, 1,3-dioxolane, dimethoxyethane, carbon tetrachloride, ethyl acetate, isopropanol, acetonitrile, ethyl acetate, methyl formate, methyl propionate, and dimethyl carbonate.

Preferably, in the first polymer precursor, a mass fraction of the reactive monomer is 66.7%-83.3%, a mass fraction of the cross-linking agent is 0-20%, and a mass fraction of the lithium salt is 10%-16.7%;
in the second polymer precursor, a mass fraction of the initiator is 2.1%-2.9%, and a mass fraction of the solubilizer is 97.1%-97.9%; and
a mass ratio of the first polymer precursor to the second polymer precursor added is (2.9-4.4): 1.

The above preferred addition amount formulations are all optimized conditions confirmed by multiple experiments to ensure that the reactive monomer can be polymerized and meet electrical performance requirements of the battery cell. When the experiments are not conducted under the optimized conditions, a result, such as failed polymerization/over-polymerization of the reactive monomer or severe deterioration of electrical performance of the battery cell, occurs. For example, when the content of the initiator is insufficient, a polymerization degree is inadequate, and a solid-state electrolyte cannot be formed. When the content of the initiator added is excessive, defects, such as too many active sites of the initiator, failed formation of a long-chain polymer, and an insufficient solidification degree of the electrolyte, are caused. For example, when the cross-linking agent is added, linear high-molecular long chains form a network structure through combination of chemical bonds, and the network structure can increase mechanical strength and other properties of the electrolyte. However, when the content of the cross-linking agent added is excessive, adverse effects, such as a dense network, high hardness of the electrolyte, decrease of ionic conductivity, increase of internal resistance of the battery cell, and decrease of capacity, are caused.

Preferably, in the step (3), a temperature of the in-situ polymerization is 60-90° C., a polymerization time is 10 min-24 h, and a polymerization pressure is controlled at 0.2 MPa-500 MPa.

Preferably, conditions for the first formation are as follows: a charging current is 0.01 C-0.5 C, and a charging time is 30 min-360 min; and
conditions for the second formation are as follows: a charging current is 0.01 C-0.5 C, and a charging cutoff voltage is a rated voltage.

Preferably, both the first degassing and the second degassing are performed for a degassing time of 1-20 s at a degassing vacuum degree of −95 kPa to −20 kPa;
after the first degassing, high-temperature aging is performed at a high-temperature aging temperature of 45-60° C. for a time of 12-120 h; and
after the second degassing, standing is performed for a standing time of 1-30 min.

Preferably, during the first liquid injection and the second liquid injection, an environmental dew point is controlled at −60° C. to −35° C., and a vacuum degree is −98 kPa to −20 kPa.

Preferably, during the vacuum degassing to remove the solubilizer, a degassing time is 2-10 min, and a degassing vacuum degree is −98 kPa to −20 kPa.

The above process parameters are all optimized conditions confirmed by multiple experiments to meet the electrical performance requirements of the battery cell. When the experiments are not conducted under the optimized conditions, a result, such as increase of side reactions or severe deterioration of electrical performance of the battery cell, occurs. For example, an excessive charging current leads to uneven formation of a solid electrolyte interphase (SEI) on an electrode surface, thereby affecting capacity utilization and long-term cycle performance. For example, a too low polymerization temperature leads to an insufficient polymerization degree, and a too high polymerization temperature triggers side reactions between an electrode and an electrolyte, thereby reducing battery cell capacity and affecting cycle life.

The present disclosure further provides a solid-state battery prepared by the preparation method.

Compared with the prior art, the present disclosure has the following beneficial effects. In view of defects such as excessive gas production, simultaneous bubble solidification, low initial efficiency and poor cycle performance of in-situ polymerized lithium-ion pouch batteries using existing one-step liquid injection polymerization, for a solid-state lithium-ion pouch battery using an in-situ polymerization method, a process route involving a two-time liquid injection process capable of achieving an interface-free effect is proposed, thereby allowing an electrolyte solution to undergo full formation before in-situ polymerization, a full reaction, full gas production and degassing, and achieving the purposes of bubble-free solidification, improving initial efficiency and improving cycle performance of a battery cell. The use of two-time formation is conducive to forming a stable solid electrolyte interface membrane in the battery and conducive to improving cycle performance of the battery. With respect to the problem that initiators cannot be injected, the initiator is mixed with a small amount of the volatile solubilizer to form the second polymer precursor, the first polymer precursor and the second polymer precursor are injected separately, a subsequent process route and process parameters of the in-situ polymerization are correspondingly adjusted, and then, the added volatile solubilizer is discharged by means of vacuum extraction, so as to prepare an all-solid-state polymer battery. The second polymer precursor and the first polymer precursor can be fully mixed by the in-situ polymerization under a certain polymerization pressure, thereby making a polymerization reaction more uniform. The technological transformation from academic research to an actual product becomes possible, and a solid-state lithium-ion battery that can meet requirements of real-world scenarios can be produced.

### BRIEF DESCRIPTION OF THE DRAWINGS

FIG. 1 is a process route diagram of a production process flow of an interface-free solid-state pouch battery.

FIG. 2 is an image showing detection results of a common bubble phenomenon in an in-situ solidification process.

### DETAILED DESCRIPTION OF THE EMBODIMENTS

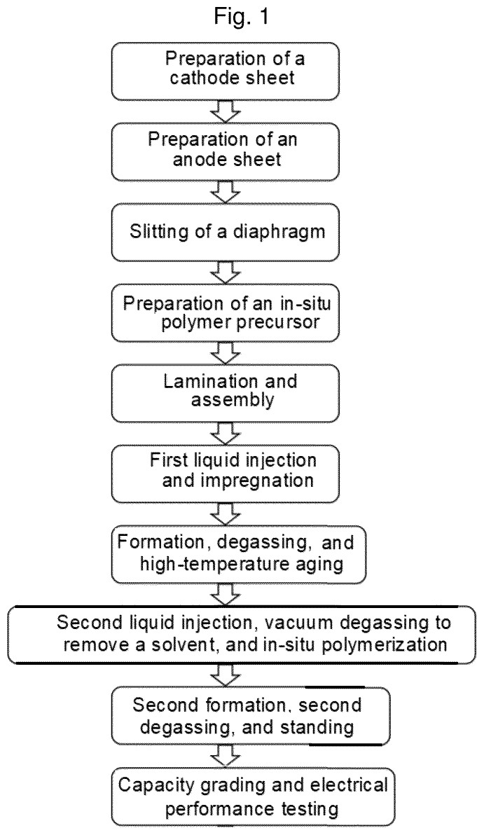

As shown in FIG. 1, a process route diagram of a production process flow of an interface-free solid-state pouch battery of the present disclosure is provided. The production process flow includes: preparation of a cathode sheet, preparation of an anode sheet, slitting of a diaphragm, preparation of a polymer precursor for in-situ polymerization, lamination, assembly, first liquid injection, impregnation, formation, degassing, high-temperature aging, second liquid injection, vacuum degassing to remove a solvent (solubilizer), in-situ polymerization, second formation, second degassing, standing, capacity grading, and electrical performance testing.

### Example 1

Preparation of a vinylene carbonate (VC) system interface-free solid-state pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a first polymer precursor for in-situ polymerization: 130 g of vinylene carbonate (VC) as a reactive monomer, 20 g of poly(ethylene glycol) diacrylate (PEGDA) as a cross-linking agent and 30 g of LiPF₆ as a lithium salt were fully stirred for 4 h to obtain the first polymer precursor for in-situ polymerization.

3. Preparation of a second polymer precursor for in-situ polymerization: 1.3 g of azobisisobutyronitrile (AIBN) as an initiator was injected into 50 g of dimethyl carbonate (DMC) and then fully stirred for 6 h to obtain the second polymer precursor for in-situ polymerization.

4. The cathode sheet and the anode sheet prepared in the step 1 and the diaphragm were laminated, assembled, and dried to prepare a dry battery cell without liquid injection (in the present disclosure, the dry battery cell includes an aluminum-plastic film shell on an exterior of the battery, same below).

5. The first polymer precursor for in-situ polymerization prepared in the step 2 was injected into the dry battery cell prepared in the step 4 to perform first liquid injection, where an environmental dew point during the liquid injection was controlled at −60° C., and a vacuum degree was −98 kPa; and after the liquid injection, standing was performed for impregnation at normal temperature for 72 h.

6. The battery cell after the liquid injection prepared in the step 5 was subjected to high-temperature aging, formation and degassing processes. An aging temperature was 45° C., and an aging time was 48 h; formation conditions were as follows: a charging current was 0.01 C, and a charging time was 60 min; and a degassing time was 5 s, and a degassing vacuum degree was −90 kPa.

7. The second polymer precursor for in-situ polymerization prepared in the step 3 was injected into the battery cell prepared in the step 6 to perform second liquid injection, where an environmental dew point of the liquid injection was controlled at −60° C., and a vacuum degree was −98 kPa.

8. The battery cell after the liquid injection prepared in the step 7 was subjected to vacuum degassing to remove the DMC as a solvent, and then placed in a high-temperature environment at 60° C. for in-situ polymerization at a polymerization pressure of 0.2 Mpa for a reaction time of 1 h to obtain a solidified electrolyte. A degassing time was 5 min, and a degassing vacuum degree was −98 kPa.

9. The battery cell prepared in the step 8 was subjected to second formation, second degassing, standing and capacity grading processes to complete preparation of the solid-state battery. A charging current for the second formation was 0.5 C, and a charging cutoff voltage was 4.2 V. A second degassing time was 20 s, and a degassing vacuum degree was −20 kPa. A standing time was 30 min.

10. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that no bubbles are observed in the solidified electrolyte.

### Example 2

Preparation of a poly(ethylene glycol) methacrylate (PEGMA) interface-free solid-state pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a first polymer precursor for in-situ polymerization: 120 g of poly(ethylene glycol) methacrylate (PEGMA) as a reactive monomer, 36 g of poly(ethylene glycol) dimethacrylate (PEGDMA) as a cross-linking agent and 24 g of LiBF₄ as a lithium salt were fully stirred for 4 h to obtain the first polymer precursor for in-situ polymerization.

3. Preparation of a second polymer precursor for in-situ polymerization: 1.2 g of azobisisobutyronitrile (AIBN) as an initiator was injected into 40 g of ethyl acetate and then fully stirred for 6 h to obtain the second polymer precursor for in-situ polymerization.

4. The cathode sheet and the anode sheet prepared in the step 1 and the diaphragm were laminated, assembled, and dried to prepare a dry battery cell without liquid injection.

5. The first polymer precursor for in-situ polymerization prepared in the step 2 was injected into the dry battery cell prepared in the step 4 to perform first liquid injection, where an environmental dew point during the liquid injection was controlled at −60° C., and a vacuum degree was −90 kPa; and after the liquid injection, standing was performed for impregnation at normal temperature for 72 h.

6. The battery cell after the liquid injection prepared in the step 5 was subjected to high-temperature aging, formation and degassing processes. An aging temperature was 60° C., and an aging time was 12 h; formation conditions were as follows: a charging current was 0.33 C, and a charging time was 60 min; and a degassing time was 1 s, and a degassing vacuum degree was −20 kPa.

7. The second polymer precursor for in-situ polymerization prepared in the step 3 was injected into the battery cell prepared in the step 6 to perform second liquid injection, where an environmental dew point during the liquid injection was controlled at −60° C., and a vacuum degree was −90 kPa.

8. The battery cell after the liquid injection prepared in the step 7 was subjected to vacuum degassing to remove the ethyl acetate as a solvent, and then placed in a high-temperature environment at 80° C. for in-situ polymerization at a polymerization pressure of 50 Mpa for a reaction time of 2 h to obtain a solidified electrolyte. A degassing time was 2 min, and a degassing vacuum degree was −98 kPa.

9. The battery cell prepared in the step 8 was subjected to second formation, second degassing, standing and capacity grading processes to complete preparation of the solid-state battery. A charging current for the second formation was 0.33 C, and a charging cutoff voltage was 4.2 V. A second degassing time was 1 s, and a degassing vacuum degree was −90 kPa. A standing time was 30 min.

10. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that no bubbles are observed in the solidified electrolyte.

### Example 3

Preparation of a poly(1,3-dioxolane) (P (DOL)) interface-free solid-state pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a first polymer precursor for in-situ polymerization: 140 g of 1,3-dioxolane (DOL) as a reactive monomer, 22 g of trimethylolpropane trimethacrylate as a cross-linking agent and 18 g of LiTFSI as a lithium salt were fully stirred for 4 h to obtain the first polymer precursor for in-situ polymerization.

3. Preparation of a second polymer precursor for in-situ polymerization: 1.4 g of aluminum trifluoromethanesulfonate (Al(OTf)₃) as an initiator was injected into 50 g of methyl formate and then fully stirred for 6 h to obtain the second polymer precursor for in-situ polymerization.

4. The cathode sheet and the anode sheet prepared in the step 1 and the diaphragm were laminated, assembled, and dried to prepare a dry battery cell without liquid injection.

5. The first polymer precursor for in-situ polymerization prepared in the step 2 was injected into the dry battery cell prepared in the step 4 to perform first liquid injection, where an environmental dew point during the liquid injection was controlled at −35° C., and a vacuum degree was −45 kPa; and after the liquid injection, standing was performed for impregnation at normal temperature for 72 h.

6. The battery cell after the liquid injection prepared in the step 5 was subjected to high-temperature aging, formation and degassing processes. An aging temperature was 60° C., and an aging time was 12 h; formation conditions were as follows: a charging current was 0.33 C, and a charging time was 120 min; and a degassing time was 10 s, and a degassing vacuum degree was-90 kPa.

7. The second polymer precursor for in-situ polymerization prepared in the step 3 was injected into the battery cell prepared in the step 6 to perform second liquid injection, where an environmental dew point during the liquid injection was controlled at −35° C., and a vacuum degree was −45 kPa.

8. The battery cell after the liquid injection prepared in the step 7 was subjected to vacuum degassing to remove the methyl formate as a solvent, and then placed in a high-temperature environment at 70° C. for in-situ polymerization at a polymerization pressure of 200 Mpa for a reaction time of 3 h to obtain a solidified electrolyte. A degassing time was 5 min, and a degassing vacuum degree was −90 kPa.

9. The battery cell prepared in the step 8 was subjected to second formation, second degassing, standing and capacity grading processes to complete preparation of the solid-state battery. A charging current for the second formation was 0.01 C, and a charging cutoff voltage was 4.2 V. A second degassing time was 10 s, and a degassing vacuum degree was −50 kPa. A standing time was 20 min.

10. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that no bubbles are observed in the solidified electrolyte.

### Example 4

Preparation of a pentaerythritol triacrylate interface-free solid-state pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a first polymer precursor for in-situ polymerization: 130 g of pentaerythritol triacrylate as a reactive monomer, 30 g of poly(ethylene glycol) diacrylate as a cross-linking agent and 20 g of LiFSI as a lithium salt were fully stirred for 4 h to obtain the first polymer precursor for in-situ polymerization.

3. Preparation of a second polymer precursor for in-situ polymerization: 1.3 g of di-tert-butyl peroxide as an initiator was injected into 60 g of tetrahydrofuran and then fully stirred for 6 h to obtain the second polymer precursor for in-situ polymerization.

4. The cathode sheet and the anode sheet prepared in the step 1 and the diaphragm were laminated, assembled, and dried to prepare a dry battery cell without liquid injection.

5. The first polymer precursor for in-situ polymerization prepared in the step 2 was injected into the dry battery cell prepared in the step 4 to perform first liquid injection, where an environmental dew point during the liquid injection was controlled at −35° C., and a vacuum degree was −20 kPa; and after the liquid injection, standing was performed for impregnation at normal temperature for 72 h.

6. The battery cell after the liquid injection prepared in the step 5 was subjected to high-temperature aging, formation and degassing processes. An aging temperature was 45° C., and an aging time was 120 h; formation conditions were as follows: a charging current was 0.5 C, and a charging time was 30 min; and a degassing time was 5 s, and a degassing vacuum degree was −20 kPa.

7. The second polymer precursor for in-situ polymerization prepared in the step 3 was injected into the battery cell prepared in the step 6 to perform second liquid injection, where an environmental dew point during the liquid injection was controlled at −35° C., and a vacuum degree was −20 kPa.

8. The battery cell after the liquid injection prepared in the step 7 was subjected to vacuum degassing to remove the tetrahydrofuran as a solvent, and then placed in a high-temperature environment at 60° C. for in-situ polymerization at a polymerization pressure of 500 Mpa for a reaction time of 24 h to obtain a solidified electrolyte. A degassing time was 10 min, and a degassing vacuum degree was −20 kPa.

9. The battery cell prepared in the step 8 was subjected to second formation, second degassing, standing and capacity grading processes to complete preparation of the solid-state battery. A charging current for the second formation was 0.33 C, and a charging cutoff voltage was 4.2 V. A second degassing time was 10 s, and a degassing vacuum degree was −90 kPa. A standing time was 1 min.

10. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that no bubbles are observed in the solidified electrolyte.

### Example 5

Preparation of an ethoxyethyl acrylate interface-free solid-state pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a first polymer precursor for in-situ polymerization: 150 g of ethoxyethyl acrylate as a reactive monomer and 30 g of LiBF₆ as a lithium salt were fully stirred for 4 h to obtain the first polymer precursor for in-situ polymerization.

3. Preparation of a second polymer precursor for in-situ polymerization: 1.5 g of tributyltin oxide was injected into 50 g of 2-methyltetrahydrofuran and then fully stirred for 6 h to obtain the second polymer precursor for in-situ polymerization.

4. The cathode sheet and the anode sheet prepared in the step 1 and the diaphragm were laminated, assembled, and dried to prepare a dry battery cell without liquid injection.

5. The first polymer precursor for in-situ polymerization prepared in the step 2 was injected into the dry battery cell prepared in the step 4 to perform first liquid injection, where an environmental dew point during the liquid injection was controlled at −60° C., and a vacuum degree was −95 kPa; and after the liquid injection, standing was performed for impregnation at normal temperature for 72 h.

6. The battery cell after the liquid injection prepared in the step 5 was subjected to high-temperature aging, formation and degassing processes. An aging temperature was 45° C., and an aging time was 24 h; formation conditions were as follows: a charging current was 0.01 C, and a charging time was 360 min; and a degassing time was 10 s, and a degassing vacuum degree was-95 kPa.

7. The second polymer precursor for in-situ polymerization prepared in the step 3 was injected into the battery cell prepared in the step 6 to perform second liquid injection, where an environmental dew point during the liquid injection was controlled at −60° C., and a vacuum degree was −95 kPa.

8. The battery cell after the liquid injection prepared in the step 7 was subjected to vacuum degassing to remove the 2-methyltetrahydrofuran as a solvent, and then placed in a high-temperature environment at 90° C. for in-situ polymerization at a polymerization pressure of 20 Mpa for a reaction time of 10 min to obtain a solidified electrolyte A degassing time was 5 min, and a degassing vacuum degree was −95 kPa.

9. The battery cell prepared in the step 8 was subjected to second formation, second degassing, standing and capacity grading processes to complete preparation of the solid-state battery. A charging current for the second formation was 0.33 C, and a charging cutoff voltage was 4.2 V. A second degassing time was 15 s, and a degassing vacuum degree was −60 kPa. A standing time was 30 min.

10. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that no bubbles are observed in the solidified electrolyte.

### Comparative Example 1

Preparation of a solid-state pouch battery obtained by in-situ polymerization using a one-time liquid injection method is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode sheet and the graphite anode sheet.

2. Preparation of a polymer precursor for in-situ polymerization: 130 g of vinylene carbonate (VC) as a reactive monomer, 20 g of poly(ethylene glycol) diacrylate (PEGDA) as a cross-linking agent, 30 g of LiPF₆ as a lithium salt and 1.3 g of azobisisobutyronitrile (AIBN) as an initiator were fully stirred for 6 h to obtain the polymer precursor for in-situ polymerization.

3. The cathode sheet and the anode sheet prepared in the step 1 and the diaphragm were laminated, assembled, and dried to prepare a dry battery cell without liquid injection.

4. The polymer precursor for in-situ polymerization prepared in the step 2 was injected into the dry battery cell prepared in the step 3, where an environmental dew point during the liquid injection was controlled at −60° C., and a vacuum degree was −98 kPa; and after the liquid injection, standing was performed for impregnation at normal temperature for 72 h.

5. The battery cell after the liquid injection prepared in the step 4 was placed in a high-temperature environment at 60° C. for in-situ polymerization at a polymerization pressure of 0.2 Mpa for a reaction time of 24 h to obtain a solidified electrolyte.

6. The battery cell prepared in the step 5 was subjected to formation, degassing, high-temperature aging and capacity grading processes to complete preparation of the solid-state battery, where an aging temperature was 45° C., and an aging time was 48 h. Formation conditions were as follows: a charging current was 0.01 C, and a charging time was 60 min; and a degassing time was 10 s, and a degassing vacuum degree was −90 kPa.

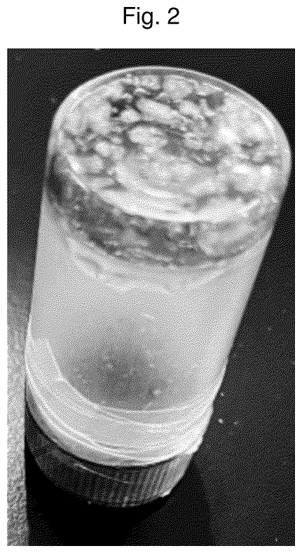

7. A capacity test, a cycle test, an electrical performance test and safety performance tests such as a needle puncture test and an overcharge test were carried out on the prepared solid-state battery, and the battery cell was disassembled to observe the number of bubbles in the solidified electrolyte. It is found that bubbles are observed in the solidified electrolyte. Bubble situations of the solid-state electrolyte obtained by the in-situ polymerization using the one-time liquid injection method were simulated in a bottle. As shown in FIG. 2, a large number of bubbles are observed.

### Comparative Example 2

Preparation of a liquid pouch battery is provided in the following specific solution.

1. A ternary cathode sheet was prepared by processes such as homogenization, coating, rolling, slitting, and die cutting, a graphite anode sheet was prepared by processes such as homogenization, coating, rolling, slitting, and die cutting, and an alumina-coated diaphragm was used for lamination with the ternary cathode and the graphite anode sheet.

2. The cathode sheet and the anode sheet prepared in the step 1 and the diaphragm were laminated, assembled, and dried to prepare a dry battery cell without liquid injection.

3. An electrolyte solution (ethylene carbonate (EC):ethyl methyl carbonate (EMC):diethyl carbonate (DEC)=1:1:1, LiPF₆ at 1 mol/L) was formulated and injected into the dry battery cell prepared in the step 2, where an environmental dew point during the liquid injection was controlled at −60° C., and a vacuum degree was −90 kPa; and after the liquid injection, standing was performed for impregnation at normal temperature for 72 h.

4. The battery cell after the liquid injection prepared in the step 3 was subjected to formation, degassing and high-temperature aging processes, where an aging temperature was 45° C., and an aging time was 48 h. Formation conditions were as follows: a charging current was 0.01 C, and a charging time was 360 min; and a degassing time was 10 s, and a degassing vacuum degree was-90 kPa.

5. A capacity test, a cycle test, an electrical performance test and safety performance tests such as a needle puncture test and an overcharge test were carried out on the prepared liquid lithium battery, and the battery cell was disassembled to observe the number of bubbles in the electrolyte solution. It is found that no bubbles are observed in the electrolyte solution.

### Test Example 1

1. Cycle test: The cycle test was carried out according to the national standard GB/T31484-2015, specifically including the following steps:
(a) performing discharging to 2.75 V at a constant current of 111 (A);
(B) performing resting for 30 min;
(c) performing charging to 4.2 V at a constant current of 111 (A), and then performing charging to 0.0511 (A) at a constant voltage;
(d) performing resting for 30 min;
(e) performing discharging to 2.75 V at a constant current of 111 (A); and
(f) repeating the steps (b)-(e) for 100-1,000 cycles.

2. Needle puncture test: The needle puncture test was carried out according to the national standard GB/T31485-2015, specifically including the following steps:
(a) charging a battery to 4.2 V at a constant current of 11 (A), and then performing charging to 0.0511 (A) at a constant voltage;
(b) using a Φ5 mm high-temperature resistant steel needle (a needle tip has a cone angle of 45°-60°, and a needle surface is smooth and free of rust, oxide layer and oil stain) to penetrate through the battery from a direction perpendicular to a electrode plate at a speed of (25±5) mm/s, where a penetration position was close to a geometric center of a punctured surface, and the steel needle was remained in the battery; and
(c) performing observation for 1 h.

TABLE 1
Statistical test results of batteries
in examples and comparative examples

| | Presence of | | |
|---|---|---|---|
| | bubbles in an | | |
| | electrolyte | | |
| | (electrolyte | Electrical | |
| | solution) | performance | Safety performance |
| Example 1 | No | 500 cycles | Needle puncture passed |
| Example 2 | No | 500 cycles | Needle puncture passed |
| Example 3 | No | 500 cycles | Needle puncture passed |
| Example 4 | No | 500 cycles | Needle puncture passed |
| Example 5 | No | 500 cycles | Needle puncture passed |
| Comparative | Yes | 100 cycles | Needle puncture passed |
| Example 1 | | | |
| Comparative | No | 1000 cycles | Needle puncture passed |
| Example 2 | | | |

TABLE 2
Capacity data of different solid-state batteries
obtained according to examples

| Battery sample | Discharge capacity/Ah |
|---|---|
| Liquid battery (Comparative Example 2) | 52.2 |
| Solid-state battery 1 (Example 1) | 52.7 |
| Solid-state battery 2 (Example 2) | 52.1 |
| Solid-state battery 3 (Example 3) | 50.2 |
| Solid-state battery 4 (Example 4) | 48.5 |
| Solid-state battery 5 (Example 5) | 51.7 |
| Solid-state battery 6 (Comparative Example 1) | 41.2 |

Result analysis: According to the results of Example 1, Example 2, Example 3, Example 4 and Example 5, it can be seen that an in-situ polymerization process route of the present disclosure is applicable to various in-situ polymerization systems and is a universal process route. The in-situ polymerization process route of the present disclosure has high compatibility with existing lithium-ion battery production lines, which can prepare required solid-state batteries without the need for customized special equipment.

By comparing the results of examples with Comparative Example 1, it can be seen that compared with a conventional in-situ polymerization process route, the in-situ polymerization process route of the present disclosure prepares the solid-state batteries with higher in-situ polymerization uniformity and more controllable solidification degrees, and eliminates impacts of adverse factors such as bubbles, so that electrical performance of the batteries is significantly improved.

By comparing the results of examples with Comparative Example 2, it can be seen that compared with a conventional liquid lithium battery process route, the in-situ polymerization process route of the present disclosure greatly improves safety of the solid-state batteries, and the solid-state batteries of the present disclosure can all pass tests such as needle puncture and high-voltage overcharge that cannot be passed by the liquid-state battery.

What is claimed is:

1. A method for preparing a solid-state battery, wherein the solid-state battery comprises a dry battery cell, and the preparation method comprises the following steps:
(1) performing first liquid injection into the dry battery cell by injecting a first polymer precursor, wherein the first polymer precursor comprises a reactive monomer and a lithium salt, and further comprises or does not comprise a cross-linking agent;
(2) performing first formation and then first degassing;
(3) performing second liquid injection by injecting a second polymer precursor, wherein the second polymer precursor comprises an initiator and a solubilizer, and the solubilizer is volatile solvent;
(4) performing vacuum degassing to remove the solubilizer, and then allowing the reactive monomer and the cross-linking agent to undergo in-situ polymerization under the action of the initiator; and
(5) performing second formation and second degassing.

2. The method for preparing a solid-state battery according to claim 1, wherein the reactive monomer is selected from the group consisting of: vinyl acetate, dimethyl allyldicarboxylate, diethyl allylmalonate, dimethallyl carbonate, 1,4-butanediol diacrylate, 1,6-hexanediol diacrylate, methyl methacrylate, butyl methacrylate, vinylene carbonate, vinylethylene carbonate, methyl vinyl sulfone, ethyl vinyl sulfone, ethoxylated trimethylolpropane triacrylate, pentaerythritol triacrylate, pentaerythritol tetraacrylate, dipentaerythritol pentaacrylate, dipentaerythritol hexaacrylate, acrylamide, N,N-methylenebisacrylamide, caprolactam, butyrolactam, maleic anhydride, acrylonitrile, ethyl 2-cyanoacrylate, butyl 2-cyano-2-acrylate, isooctyl 2-cyano-3,3-diphenylacrylate, 1-cyclohexene acetonitrile, hexafluorobutyl methacrylate, trifluoroethyl methacrylate, poly(ethylene glycol) methacrylate, poly(ethylene glycol) dimethacrylate, poly(ethylene glycol) diacrylate, ethoxyethyl acrylate, polyethylene glycol, 1,3-dioxolane, dioxane, vinylmethoxysilane, ethyl 2-(trimethylsiloxy) methacrylate, trivinylcyclotrisiloxane, and tris(2-methoxyethoxy) vinylsilane.

3. The method for preparing a solid-state battery according to claim 1, wherein the solubilizer is selected from the group consisting of: ethyl ether, pentane, dichloromethane, carbon disulfide, acetone, chloroform, tetrahydrofuran, 2-methyltetrahydrofuran, ethanol, methanol, hexane, 1,3-dioxolane, dimethoxyethane, carbon tetrachloride, ethyl acetate, isopropanol, acetonitrile, ethyl acetate, methyl formate, methyl propionate, and dimethyl carbonate.

4. The method for preparing a solid-state battery according to claim 1, wherein in the first polymer precursor, a mass fraction of the reactive monomer is 66.7%-83.3%, a mass fraction of the cross-linking agent is 0-20%, and a mass fraction of the lithium salt is 10%-16.7%.

5. The method for preparing a solid-state battery according to claim 1, wherein in the step (4), a temperature of the in-situ polymerization is 60-90° C., a polymerization time is 10 min-24 h, and a polymerization pressure is controlled at 0.2 MPa-500 MPa.

6. The method for preparing a solid-state battery according to claim 1, wherein conditions for the first formation are as follows: a charging current is 0.01 C-0.5 C, and a charging time is 30 min-360 min.

7. The method for preparing a solid-state battery according to claim 1, wherein both the first degassing and the second degassing are performed for a degassing time of 1-20 s at a degassing vacuum degree of −95 kPa to −20 kPa.

8. The method for preparing a solid-state battery according to claim 1, wherein during the first liquid injection and the second liquid injection, an environmental dew point is controlled at −60° C. to −35° C., and a vacuum degree is −98 kPa to −20 kPa.

9. The method for preparing a solid-state battery according to claim 1, wherein during the vacuum degassing to remove the solubilizer, a degassing time is 2-10 min, and a degassing vacuum degree is −98 kPa to −20 kPa.

10. A solid-state battery prepared by the preparation method according to claim 1.

11. The method for preparing a solid-state battery according to claim 1, wherein the cross-linking agent is selected from the group consisting of: poly(ethylene glycol) diacrylate, poly(ethylene glycol) dimethacrylate, trimethylolpropane trimethacrylate, pentaerythritol tetraacrylate, pentaerythritol triacrylate, ethoxylated trimethylolpropane triacrylate, and polyether polyacrylate.

12. The method for preparing a solid-state battery according to claim 1, wherein the lithium salt is selected from the group consisting of: LiBF₄, LiBF₆, LiFSI, LiTFSI, LiAsF₆, LiPF₆, LiClO₄, LiB(C₆H₅)₄, LiAlCl₄, LiBr, LiCF₃SO₃, LiN(CF₃SO₂)₂, LiC(CF₃SOSO₂)₃, LiN(SO₂C₂F₅)₂, and Li[B(O₄C₂)]₂.

13. The method for preparing a solid-state battery according to claim 1, wherein the initiator is selected from the group consisting of: azobisisobutyronitrile, azobisisoheptonitrile, dimethyl azobisisobutyrate, benzoyl peroxide, tert-butyl benzoyl peroxide, methyl ethyl ketone peroxide, di-tert-butyl peroxide, aluminum trifluoromethanesulfonate, magnesium trifluoromethanesulfonate, lithium bis(fluorosulfonyl)imide, and tin trifluoromethanesulfonate.

14. The method for preparing a solid-state battery according to claim 1, wherein in the second polymer precursor, a mass fraction of the initiator is 2.1%-2.9%, and a mass fraction of the solubilizer is 97.1%-97.9%.

15. The method for preparing a solid-state battery according to claim 1, wherein a mass ratio of the first polymer precursor to the second polymer precursor added is (2.9-4.4): 1.

16. The method for preparing a solid-state battery according to claim 1, wherein conditions for the second formation are as follows: a charging current is 0.01 C-0.5 C, and a charging cutoff voltage is a rated voltage.

17. The method for preparing a solid-state battery according to claim 1, wherein after the first degassing, high-temperature aging is performed at a high-temperature aging temperature of 45-60° C. for a time of 12-120 h.

18. The method for preparing a solid-state battery according to claim 1, wherein after the second degassing, standing is performed for a standing time of 1-30 min.
